(19) United States
(12) Patent Application Publication
(10) Pub. No.: US 2023/0420169 A1
(43) Pub. Date: Dec. 28, 2023

(54) BISTABLE ELECTROMAGNETIC ACTUATOR AND AIRCRAFT BRAKE VALVE PROVIDED WITH SUCH AN ACTUATOR

(71) Applicant: SAFRAN LANDING SYSTEMS, Velizy Villacoublay (FR)

(72) Inventors: Laurent MONSAINT, Moissy-Cramayel (FR); Julien GLINEC, Moissy-Cramayel (FR); Guillaume DURAND, Moissy-Cramayel (FR); Mathieu GENGOUX, Moissy-Cramayel (FR)

(73) Assignee: SAFRAN LANDING SYSTEMS, Velizy Villacoublay (FR)

(21) Appl. No.: 18/036,570

(22) PCT Filed: Nov. 10, 2021
(86) PCT No.: PCT/EP2021/081294

§ 371 Date: May 11, 2023

(30) Foreign Application Priority Data
Nov. 12, 2020 (FR) 2011623

(51) Int. Cl. H01F 7/14; H01F 7/08; H01F 7/02; B64C 25/44; F16K 31/00; F16K 31/06

(52) U.S. Cl. CPC H01F 7/14; H01F 7/081; H01F 7/0205; B64C 25/44; F16K 31/003; F16K 31/0675; B60T 15/028

(57) ABSTRACT

The invention provides a bistable electromagnetic actuator comprising a yoke extending in part around a pivot axis of the actuator, an excitation coil supported by the yoke in order to generate control magnetic flux, a rotor movable about the pivot axis of the actuator and suitable for being held stationary in two stable angular positions as a function of the magnetic flux generated by the coil, an actuator member coupled to the rotor in order to form an assembly that can be turned, and a manual control device including a drive shaft dynamically coupled to the rotor in such a manner that turning the drive shaft causes the rotor to turn.

The invention relates to the field of electromagnetic actuators, and more particularly to a manually controlled pivotable electromagnetic actuator, and also to an aircraft parking brake valve including such an actuator.

### BACKGROUND OF THE INVENTION

In general manner, an aircraft wheel brake comprises both friction elements, some of which are secured to the wheel and others to the stator, and also a brake cylinder arranged to exert sufficient force on the friction elements to prevent the aircraft wheel from turning.

When parked, the brake cylinder is activated by a control device (referred to herein as the “parking brake system”) that is dedicated to parking and distinct from the device for controlling the brake cylinder while landing. The parking brake system comprises a hydraulic valve commonly referred to as a “parking brake selector valve” (PBSELV) or a “parking brake cut-off valve” (PBSOV) having a spool or a flap that is generally moved by an electromechanical actuator.

The electromechanical actuator comprises an electric motor having a stator and rotor, together with a screw and nut assembly having one of its elements driven in rotation by the rotor and having its other element prevented from rotating and constrained to slide between two positions for controlling the movement of the spool or of the flap.

The meshing between the assembled screw and nut is considered to be irreversible so that that type of actuator does not enable movement of said spool or of said flap to be controlled manually. However, for maintenance purposes, it would be advantageous to be able to control PBSELV/PBSOV valve when there is no electricity.

It would also be advantageous to be able to control the parking brake manually in the event of an electrical breakdown or in the event of malfunctioning electronics.

### OBJECT OF THE INVENTION

An object of the invention is thus to propose a bistable electromagnetic actuator that can be controlled both electrically and manually in order to move a valve such as the valve of an aircraft parking brake system.

### SUMMARY OF THE INVENTION

To this end, the invention provides a bistable electromagnetic actuator comprising:
a yoke extending in part around a pivot axis of the actuator;
at least one excitation coil supported by the yoke in order to generate control magnetic flux;
a rotor movable about the pivot axis of the actuator and suitable for being held stationary in two stable angular positions as a function of the magnetic flux generated by the coil;
an actuator member coupled to the rotor in order to form an assembly that can be turned; and
a manual control device including a drive shaft dynamically coupled to the rotor in such a manner that turning the drive shaft causes the rotor to turn.

The actuator member can thus be moved by exciting the coil or by turning the drive shaft, such that the actuator can be controlled both electrically and manually.

In particular manner, the drive shaft extends along the pivot axis of the actuator.

In particular manner, the manual control device includes a handle arranged at one end of the drive shaft in order to enable said drive shaft to be turned.

In particular manner, the stroke of the rotor between its two stable angular positions is sufficient to enable the handle to constitute an indicator of the position of the rotor, the extreme angular positions of the handle being far enough apart to enable them to be distinguished from each other without hesitation by the naked eye.

In particular manner, the stroke of the rotor is substantially equal to 30°.

In particular manner, the rod has a portion pivotally received to turn about the pivot axis of the rotor in a bore formed in an end cover that is removably fitted on a casing of the actuator.

In particular manner, a sealing gasket is mounted in the bore formed in the end cover in order to provide sealing between the rod and the end cover.

In particular manner, the rotor comprises both a core made of ferromagnetic material and also at least one permanent magnet received in a groove of the core.

In a preferred embodiment of the invention, a plurality of permanent magnets are fastened on the core in order to facilitate retention of the rotor in one or the other of its stable positions in spite of vibration.

In particular manner, the actuator member and the drive shaft are made integrally with the rotor.

The invention also provides an aircraft parking brake valve including such an actuator and a valve member that is movable between two service positions. The actuator member is connected to the valve member in order to control movement of said valve member between its two service positions.

In particular manner, the valve member comprises at least one flap or at least one spool.

The invention also provides an aircraft fitted with a braking circuit including at least one such valve.

### BRIEF DESCRIPTION OF THE DRAWINGS

The invention can be better understood in the light of the following description, which is purely illustrative and nonlimiting, and which should be read with reference to the accompanying drawings, in which:

FIG. 1 is a simplified representation of an aircraft that is fitted with a braking system provided with a bistable electromagnetic actuator in a first embodiment of the invention;

FIG. 2 is a fragmentary view of the bistable electromagnetic actuator in section on a plane containing a pivot axis of the actuator;

FIG. 3 is a view of the FIG. 2 actuator in cross section on a first plane III orthogonal to the pivot axis of the actuator and shown in one of its two stable states;

FIG. 4 is a view of the FIG. 2 actuator in cross section on a second plane IV orthogonal to the pivot axis of the actuator and shown in the middle of its stroke between its two stable states; and

FIG. 5 is a view of a second embodiment of the actuator in cross section on a plane orthogonal to the pivot axis of the actuator and shown in the middle of its stroke between its two stable states.

### DETAILED DESCRIPTION OF THE INVENTION

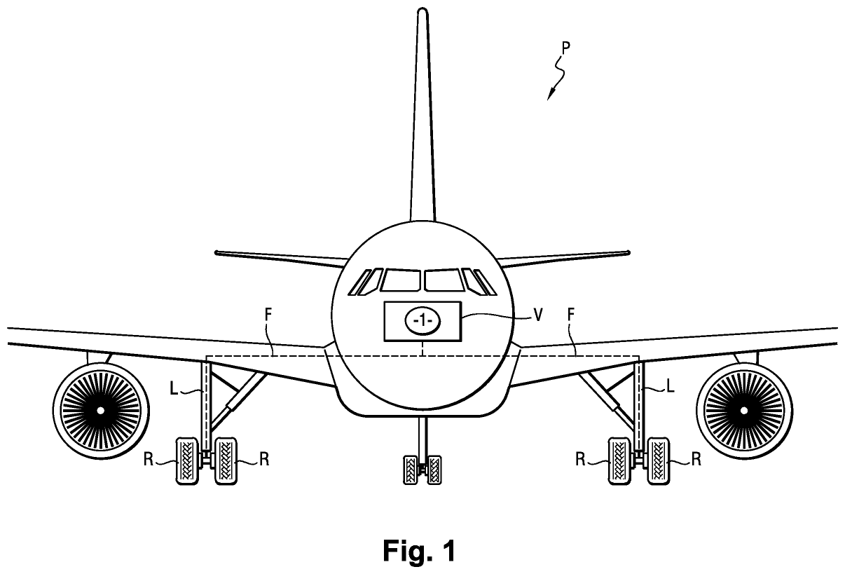

With reference to FIG. 1, the invention is described below in application to preventing rotation of wheels R mounted on the main landing gear L of an aircraft P. The aircraft P is fitted with a dedicated braking circuit F that includes a brake valve V with a valve member that is movable between two positions. Movement of the valve member is controlled by a bistable electromagnetic actuator, overall reference 1.

In a first embodiment of the invention, the actuator 1 comprises a stationary assembly given overall reference 10, and a movable assembly that is pivotable about a central axis X and that is given overall reference 20.

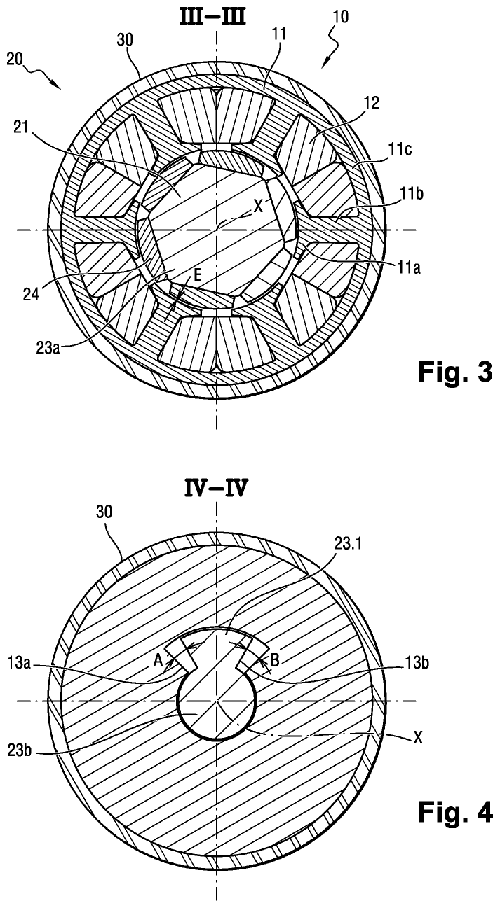

As shown in FIG. 3, the stationary assembly 10 has a yoke 11 made of ferromagnetic material. The yoke 11 has an annular portion 11c from which six identical tabs 11b project radially, forming poles 11a facing towards the axis X and uniformly distributed around said axis X. Each of the tabs 11a is surrounded by the winding of a respective electromagnetic coil 12 so that the poles 11a can be excited by the magnetic flux that is generated when the coils 12 are electrically powered.

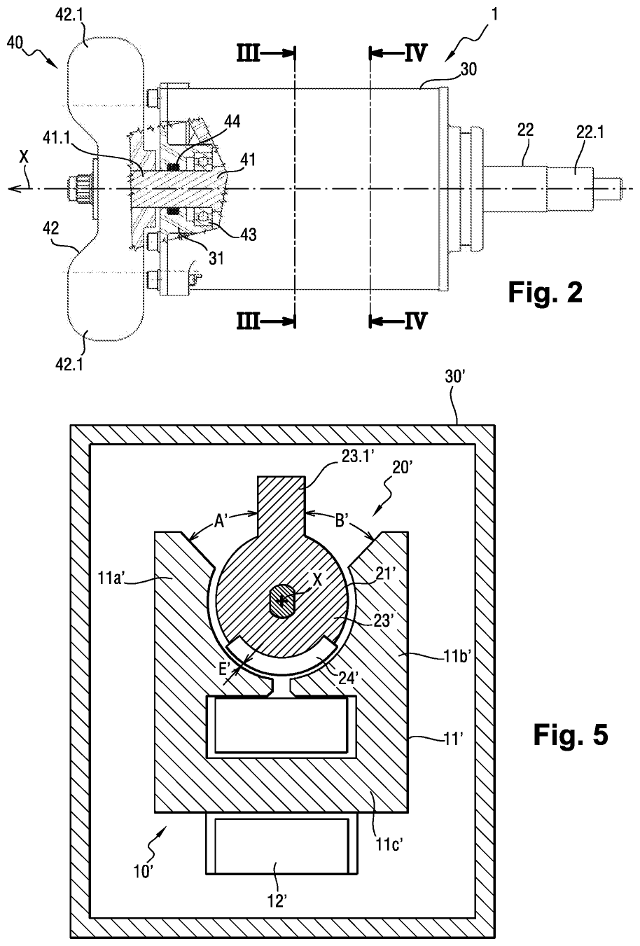

The movable assembly 20 comprises a rotor 21 that is pivotable about the axis X and a rod 22 that is coupled to the rotor 21 in order to form an actuator member extending along the axis X (FIG. 2). In this example, the rod 22 is made integrally with the rotor 21, which is made out of magnetic material.

A first portion of the rotor 21 comprises a first core 23a of hexagonal section in a plane orthogonal to the axis X, so as to define six faces. Each of the six faces has a respective permanent magnet 24 fastened thereon by being received in a groove of the core 23a. The magnets 24 are secured to the core 23a by adhesive or by shrink-fitting so as to generate permanent magnetic flux in the absence of current in the coils 12. Relative to the poles 11a of the yoke 11, the magnets 24 present a main air gap E that remains constant during pivoting of the rotor 21 about the axis X.

A second portion of the rotor 21 comprises a second core 23b that is generally cylindrical in shape (FIG. 4). The core 23b has a radial projection 23.1 that co-operates with plane surfaces 13a and 13b of a nonmagnetic body of the stationary assembly 10 to form two secondary air gaps A and B that vary when the rotor 21 moves between two angular positions that are stable while there is no current, in which positions the projection 23.1 is in contact with one or the other of the surfaces 13a and 13b. The surfaces 13a and 13b thus form abutments defining the angular stroke of the rotor 21 for passing from either one of its stable positions to the other. The projection 23.1 and the surfaces 13a and 13b are arranged in such a manner that the angular stroke of the rotor 21 is substantially equal to 30° in this example. The surfaces 13a and 13b are angularly positioned relative to the poles 11a, and the projection 23.1 is angularly positioned relative to the magnets 24 in such a manner that, when the projection 23.1 is bearing against the surface 13a or alternatively against the surface 13b, the magnets 24 exert a force of attraction on the poles 11a tending to press the projection 23.1 against the surface 13a or alternatively 13b. Thus, while the coils 12 are not powered and the projection 23.1 is bearing against the surface 13a or alternatively against the surface 13b, the rotor 21 is in a position that is stable, and the two stable positions are located on opposite sides of a middle position that is not stable.

The rod 22 is of generally cylindrical shape for turning about the axis X. A proximal end of the rod 22 is secured to the core 23b. The rod 22 can thus be turned about the axis X between two extreme positions that correspond to the stable positions of the rotor 21.

The stationary assembly 10 is held inside a reception volume that is defined by inside walls of a casing 30 made of nonmagnetic material. A distal end 22.1 of the rod 22 projects from the casing and includes a connection interface for coupling with the valve member.

The actuator 1 also comprises a manual control device 40 for turning the rotor 21 manually between its two stable positions. The control device 40 includes a rod 41 that is coupled to the core 23a in order to form a drive shaft extending along the axis X. The rods 22 and 41 thus extend from opposite ends of the rotor 21.

In this example, the rod 41 is made integrally with the core 23a. It is generally cylindrical in shape and has a portion that is pivotally received to turn about the axis X in a bore formed in an end cover 31 that is removably fitted on the casing 30. A ball bearing 43 is mounted in said bore of the end cover 31 in order to guide turning of the rod 41. A sealing gasket 44 mounted in said bore provides sealing between the rod 41 and the end cover 31. The sealing gasket 44 exerts friction forces on the rod 41 that oppose turning of said rod 41 and that therefore needed to be taken into account when designing the actuator 1. Another sealing gasket (not shown) is held captive between the end cover 31 and the casing 30 so as to provide sealing between the casing 30 and the end cover 31.

A proximal end of the rod 41 is secured to the core 23a. The rod 41 can thus be turned about the axis X between two extreme positions that correspond to the stable positions of the rotor 21.

A distal end 41.1 of the rod 41 projects from the casing 30 and is provided with a handle 42 (visible in FIG. 2) in order to turn the drive shaft 41. In this example, the handle 42 is of so-called “butterfly” shape with two identical lugs 42.1 extending symmetrically in opposite directions from the axis X and lying in a plane containing said axis X. The lugs 42.1 form grip means for turning the rod 41.

Since the rod 41 is secured to the core 23a, turning the rod 41 also causes the rotor 21 to turn towards one or the other of its stable positions.

The angular travel of the handle 42 is defined directly by the extreme positions of the rod 41 and indirectly by the stable positions of the rotor 21. Thus, in this example, this angular travel is substantially equal to 30° and may be marked on the casing 30 by a first line associated with the mention “ON” and by a second line associated with the mention “OFF”. The first line corresponds to a first extreme angular position of the handle 42 in which one of the lugs 42.1 is in line with the first line and the rotor 21 is in one of its stable positions. The second line corresponds to a second extreme angular position of the handle 42 in which said one of the lugs 42.1 is in line with the second line and the rotor 21 is in the other one of its stable positions. The handle 42 thus gives a visible indication of the angular position of the rod 41, and thus of the rotor 21 and of the rod 22. The extreme positions of the handle 42 are far enough apart to be distinguished from each other without hesitation by the naked eye.

There follows a description of the operation of the actuator 1.

In order to turn the rotor 21 towards one or the other of its stable positions, the electromagnetic coils 12 are electrically powered with a positive or negative voltage so as to generate magnetic fields attracting the core 23a in one direction or the other.

The magnetic fields generated by the coils 12 produce magnetic flux that is guided by the ferromagnetic portions of the actuator 1. The magnetic flux produces loops, each passing in succession through a first stud 11b in contact with a first coil 12, a first magnet 24, a second stud 11b in contact with a second coil 12, and a fraction of the annular portion 11c of the yoke 11.

The rotor 21 then turns about the axis X inside the yoke 11 and is pressed against one or the other of the surfaces 13a and 13b as a function of the direction in which the coils 12 are powered. The core 23b is then spaced apart from the other one of the surfaces 13a and 13b, and one of the secondary air gaps A and B is closed.

The rotor 21 passing towards one or the other of its stable positions causes the rod 22 to turn, and thus moves the valve member between its two service positions. The rotor 21 passing towards one or the other of its two extreme positions also causes the rod 41 to turn, and thus turns the handle 42.

It is also possible to control movement of the valve member manually by turning the handle 42 so as to turn the rod 41. Turning the rod 41 causes the rotor 21 turn towards one or the other of its stable positions depending on the direction in which the handle 42 is turned, thereby causing the valve member to move towards one or the other of its service positions.

In order to ensure that the rotor 21 remains in one or the other of its stable positions in spite of vibration, in compliance with the EUROCAE ED-14G and RTCADO-160G standards (paragraph 8.5.1 for sinusoidal vibration and paragraph 8.5.2 for random vibration), the studs 11a and the magnets 24 are arranged in such a manner as to exert a force of attraction on the movable assembly 20 that is substantially equal to 0.5 newton-meters (N.m). Thus, the studs 11a and the magnets 24 produce holding torque that is sufficient to ensure that the movable assembly 20 remains in one or the other of its stable positions while being subjected to several hundred times its own weight.

The electric current passing through the coils 12 is then determined so as to exert a force of attraction on the movable assembly 20 that is greater than 0.5 N.m, e.g. substantially equal to 1.5 N.m, in particular in order to overcome any friction force opposing turning of the movable assembly 20, and to do so over the entire range of temperatures in which the actuator 1 is to operate.

FIG. 5 shows an actuator 1′ that constitutes the second embodiment of the invention

The actuator 1′ differs from the actuator 1 in that the stationary assembly 10′ comprises a yoke 11′ made of ferromagnetic material that is generally horseshoe-shaped, extending in part around the axis X. The yoke 11′ has two pole pieces 11a′ and 11b′ that are connected together by a central portion 11c′ that supports an electromagnetic coil 12′. The coil 12′ comprises a winding surrounding the central portion 11c′ so as to be capable of exciting the pole pieces 11a′ and 11b′ by generating magnetic flux when the coil is electrically powered.

The movable assembly 20′ comprises a rotor 21′ that can be turned about the axis X together and the rod 22 coupled to the rotor 21′.

The rotor 21′ comprises both a core 23′ that is generally cylindrical in shape and that is made out of ferromagnetic material, and also a permanent magnet 24′ that is semi-cylindrical in shape and that is received in a groove in the core 23′. The magnet 24′ is secured to the core 23′ by adhesive or by shrink-fitting so as to generate permanent magnetic flux in the absence of current in the coil 12′. The magnet 24′ co-operates with the pole pieces 11a′ and 11b′ of the yoke 11′ to present a main air gap E′ that is constant while the rotor is turning about the axis X.

The core 23′ includes a radial projection 23.1′ that is diametrically opposite from the magnet and that co-operates with the pole pieces 11a′ and 11b′ of the yoke 11′ to define two secondary air gaps A′ and B′ that vary when the rotor 21′ moves between two angular positions that are stable when there is no current and in which the projection 23.1′ is in contact with one or the other of the pole pieces 11a′ and 11b′. The pole pieces 11a′ and 11b′ thus form abutments and they serve to close a path for the magnetic flux from the coil 12′ to the rotor 21′.

The distal ends of the rods 22 and 41 are secured to the core 23′, and they project from opposite ends thereof along the axis X.

In order to turn the rotor 21′ towards one or the other of its stable positions, the coil 12′ is electrically powered with a positive or negative voltage so as to generate a magnetic field attracting the core 23′ in one direction or the other.

The magnetic field generated by the coil 12′ produces magnetic flux that is guided by the ferromagnetic portions of the actuator 1′. The magnetic flux forms a loop and passes in succession through the central portion 11c′ of the yoke 11′ in contact with the coil 12′, one of the pole pieces 11a′ or 11b′ of the yoke 11′, the projection 23.1′ of the core 23′ in contact with the pole piece 11a′ or 11b′, the core 23′, and the permanent magnet 24′.

The rotor 21′ then turns about the axis X inside the yoke 11′ and is pressed against one or the other of the pole pieces 11a′ and 11b′ as a function of the direction in which the coil 12′ is powered. The core 23′ is then spaced apart from the other one of the pole pieces 11a′ and 11b′, and one of the secondary air gaps A′ and B′ is closed.

The rotor 21′ passing towards one or the other of its stable positions causes the rod 22 to turn, and thus moves the valve member between its two service positions. The rotor 21′ passing towards one or the other of its two extreme positions also causes the rod 41 to turn, and thus turns the handle 42.

It is also possible to control movement of the valve member manually by turning the handle 42 so as to turn the rod 41. Turning the rod 41 causes the rotor 21′ turn towards one or the other of its stable positions depending on the direction in which the handle 42 is turned, thereby causing the valve member to move towards one or the other of its service positions.

Naturally, the invention is not limited to the embodiments described, but covers any variant coming within the ambit of the invention as defined by the claims.

In particular, the actuator may be of a structure different from those described, in particular concerning the rotor and the stator.

Although above, the actuator member and the drive shaft form a single element on which the handle is mounted, the actuator member could be distinct from the drive shaft.

The number of magnets 24 and of studs 11b could be less than or greater than 6.

The invention is suitable for use with any type of actuator regardless of the device that is actuated.

By way of example, the valve member may be a flap or a spool.

1. A bistable electromagnetic actuator comprising:
a yoke extending in part around a pivot axis of the actuator;
at least one excitation coil supported by the yoke in order to generate control magnetic flux;
a rotor movable about the pivot axis of the actuator and suitable for being held stationary in two stable angular positions as a function of the magnetic flux generated by the coil;
an actuator member coupled to the rotor in order to form an assembly that can be turned; and
a manual control device including a drive shaft dynamically coupled to the rotor in such a manner that turning the drive shaft causes the rotor to turn.

2. The bistable electromagnetic actuator according to claim 1, wherein the drive shaft extends along the pivot axis of the actuator and has an end that is connected directly to the rotor.

3. The bistable electromagnetic actuator according to claim 1, wherein the manual control device includes a handle arranged at one end of the drive shaft in order to enable said drive shaft to be turned.

4. The bistable electromagnetic actuator according to claim 3, wherein the stroke of the rotor between its two stable angular positions is sufficient to enable the handle to constitute an indicator of the position of the rotor, the extreme angular positions of the handle being far enough apart to enable them to be distinguished from each other without hesitation by the naked eye.

5. The bistable electromagnetic actuator according to claim 1, wherein the stroke of the rotor is substantially equal to 30°.

6. The bistable electromagnetic actuator according to claim 1, wherein a rod of the drive shaft has a portion pivotally received to turn about the pivot axis of the rotor in a bore formed in an end cover that is removably fitted on a casing of the actuator.

7. The bistable electromagnetic actuator according to claim 6, wherein a sealing gasket is mounted in the bore formed in the end cover in order to provide sealing between the rod and the end cover.

8. The bistable electromagnetic actuator according to claim 1, wherein the rotor comprises both a core made of ferromagnetic material and also at least one permanent magnet received in a groove of the core.

9. The bistable electromagnetic actuator according to claim 8, wherein the at least one permanent magnet comprises a plurality of permanent magnets, and the plurality of permanent magnets are fastened on the core.

10. The bistable electromagnetic actuator according to claim 1, wherein the actuator member and the drive shaft are made integrally with the rotor.

11. An aircraft parking brake valve including the bistable electromagnetic actuator according to claim 1 and a valve member movable between two service positions, the actuator member being connected to the valve member in order to control movement of said valve member between its two service positions.

12. The aircraft parking brake valve according to claim 11, wherein the valve member comprises at least one flap or at least one spool.

13. An aircraft fitted with a braking circuit including at least one of the aircraft parking brake valve according to claim 11.
